(19) United States
(12) Patent Application Publication
(10) Pub. No.: US 2006/0023069 A1
(43) Pub. Date: Feb. 2, 2006

(54) Connection device

(76) Inventor: Hiroyuki Saito, Tokyo (JP)

Correspondence Address: MORGAN & FINNEGAN, L.L.P., 3 WORLD FINANCIAL CENTER, NEW YORK, NY, 10281-2101, US

(21) Appl. No.: 11/153,567

(22) Filed: Jun. 14, 2005

(30) Foreign Application Priority Data
Jun. 14, 2004 (JP) 2004-175995

(51) Int. Cl. H04N 5/225

(52) U.S. Cl. 348/207.99

(57) ABSTRACT

There is provided a connection device which has a reception portion for an image capturing device to be mounted in and communicably connects the image capturing device to multiple external devices. The connection device is provided with a selection unit adapted to select an external device to communicate with the image capturing device from among the multiple external devices; and a setting unit adapted to set the operation mode of the image capturing device to a mode for communicating the selected external device.

### CLAIM OF PRIORITY

This application claims priority from Japanese Patent Application No. 2004-175995 filed on Jun. 14, 2004, which is hereby incorporated by reference herein.

### FIELD OF THE INVENTION

The present invention relates to a connection device and the like for communicably connecting an image capturing device, such as a digital camera, a digital video camera and a mobile telephone with a camera, to multiple external devices.

### BACKGROUND OF THE INVENTION

There is currently known a system for inputting a digital image taken by an image capturing device such as a digital camera into an external device such as a personal computer (PC) via a connection device such as a cradle (for example, Japanese Patent Laid-Open No. 2003-198910). In Japanese Patent Laid-Open No. 2003-198910, it is described that an image capturing device is communicably connected to multiple external devices with the use of a connection device, and that the connection destination of the image capturing device is selected according to the direction of the image capturing device mounted on the connection device.

However, in the above-described connection device, it is impossible to change the operation mode of the image capturing device according to the connection destination of the image capturing device. Therefore, a user has to check the connection destination of the image capturing device and manually select a menu appropriate for the connection destination, which is inconvenient to the user.

### SUMMARY OF THE INVENTION

The present invention is to overcome the above-described drawbacks. For example, the present invention is to enable the operation mode of an image capturing device, such as a digital camera, a digital video camera and a mobile telephone with a camera, to be changed according to the connection destination of the image capturing device.

A connection device according to the present invention is, for example, a connection device which has a reception portion for an image capturing device to be mounted in and communicably connects the image capturing device to multiple external devices, comprising: a selection unit adapted to select an external device to communicate with the image capturing device from among the multiple external devices; and a setting unit adapted to set the operation mode of the image capturing device to a mode for communicating the selected external device.

Furthermore, a control method according to the present invention is, for example, a control method for a connection device which has a reception portion for an image capturing device to be mounted in and communicably connects the image capturing device to multiple external devices, comprising: a selection process of selecting an external device to communicate with the image capturing device from among the multiple external devices; and a setting process of setting the operation mode of the image capturing device to a mode for communicating the selected external device.

Other objects and advantages besides those discussed above shall be apparent to those skilled in the art from the description of a preferred embodiment of the invention which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a schematic diagram of a camera system according to a first embodiment of the present invention;

FIG. 2 is a schematic diagram of a cradle, an example of a connection device;

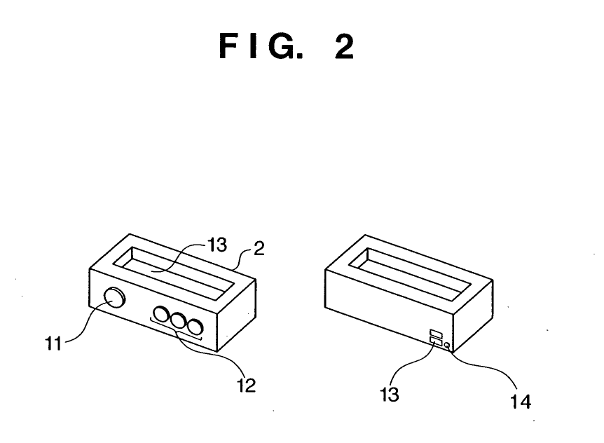

FIG. 3 shows an example of a screen to be displayed when a digital camera is connected to the cradle;

FIG. 4 shows an example of a menu to be displayed on a digital camera when a PC is selected as the connection destination;

FIG. 5 shows an example of a menu to be displayed on the digital camera when a printer is selected as the connection destination;

FIG. 6 shows an example of a menu to be displayed on the digital camera when a TV is selected as the connection destination;

FIG. 7 is a block diagram showing an example of configuration of the digital camera and the cradle;

FIG. 8 is a flowchart showing the operation of the cradle; and

FIG. 9 is a schematic diagram of a camera system according to a second embodiment of the present invention.

### DESCRIPTION OF THE PREFERRED EMBODIMENTS

The embodiments described below are only examples of the present invention and can be modified or changed as appropriate according to various conditions, and therefore, the present invention is not limited to the embodiments below.

### FIRST EMBODIMENT

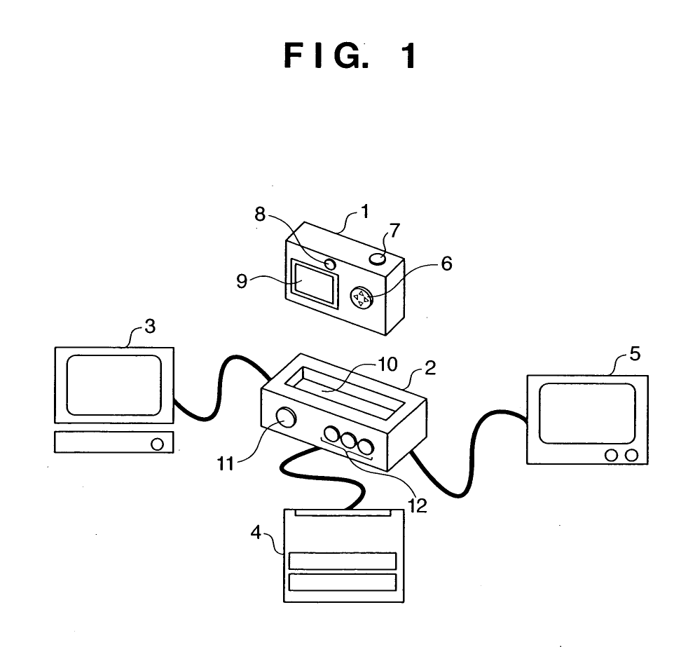

FIG. 1 is a schematic diagram of a camera system according to a first embodiment of the present invention.

As shown FIG. 1, the camera system according to this embodiment has a digital camera 1 which is an example of an image capturing device, a cradle 2 which is an example of a connection device, a personal computer (PC) 3, a printer 4 and a television set (TV) 5. The PC 3, the printer 4 and the TV 5 are external devices. The image capturing device according to the first embodiment is not limited to a digital camera, and may be any device that can operate as a digital camera, such as a digital video camera and a mobile telephone with a camera. The connection device according to the first embodiment is also not limited to a cradle and may be any device that communicably connects the digital camera 1 to the external devices 3 to 5.

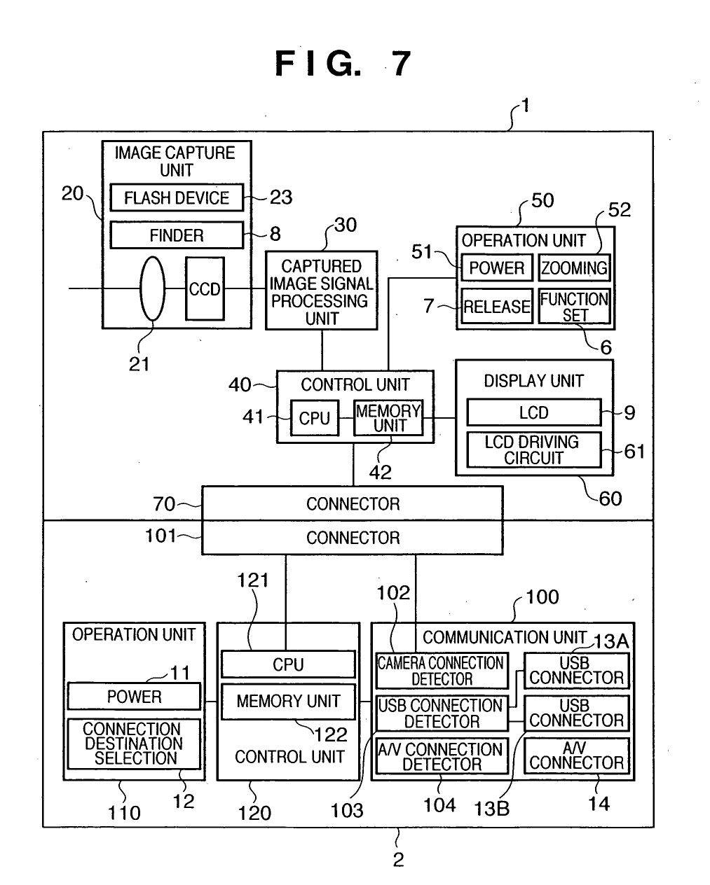

The cradle 2 has a reception portion 10 for the digital camera 1 to be mounted in. By being inserted into the reception portion 10, the digital camera 1 is enabled to communicate with the cradle 2. At a portion to be electrically in contact with the digital camera 1 (a contact point) of the reception portion 10, there is provided a camera connection detector, such as a microswitch, for detecting whether or not the digital camera 1 is mounted in the reception portion 10. The cradle 2 is provided with a USB (Universal Serial Bus) connector 13A for connecting the PC 3, a USB connector 13B for connecting the printer 4 and an A/V connector 14 for connecting the TV 5, as shown in FIG. 7. The USB connectors 13A and 13B are, for example, conformed to USB 2.0 (see Universal Serial Bus Specification Revision 2.0, Apr. 27, 2000 and the like).

The cradle 2 is provided with a connection destination selection unit 12 for enabling a user to select a connection destination of the digital camera 1. Each button within the connection destination selection unit 12 corresponds one of the PC 3, the printer 4 and the TV 5. By operating the connection destination selection unit 12, the user can select an external device to communicate with the digital camera 1. A power switch 11 is a switch for powering on or off the power source of the cradle 2.

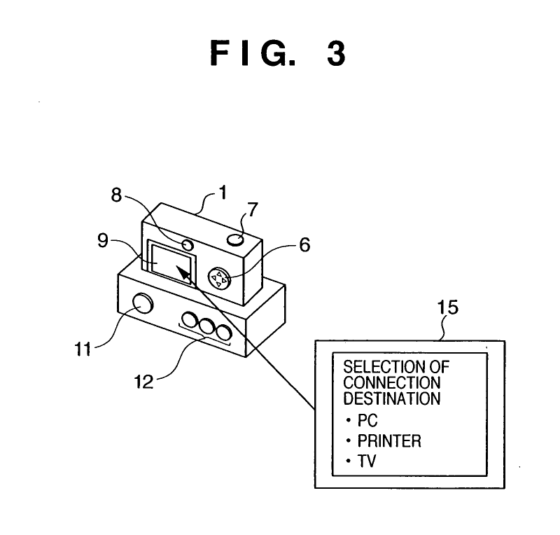

The digital camera 1 has an external form of an almost rectangular parallelepiped as shown in the figure, and is provided with a function set button 6, a release button 7, a finder 8 and a liquid crystal display (LCD) 9. When the digital camera 1 is mounted in the reception portion 10 in a manner that the LCD 9 and the connection destination selection unit 12 is in the same direction, the cradle 2 and the digital camera 1 are communicably connected to each other. If the digital camera 1 and the cradle 2 are communicably connected, the cradle 2 displays communicable external devices connected to the cradle 2 on the LCD 9 (see FIG. 3). When the user selects a desired connection destination by means of the connection destination selection unit 12, the cradle 2 sets the digital camera 1 to an operation mode corresponding to the connection destination selected by the user. A PC mode, a printer mode and a TV mode are included as operation modes. The digital camera 1 which has been set to the operation mode corresponding to the connection destination selected by the user displays a menu appropriate for the connection destination on the LCD 9.

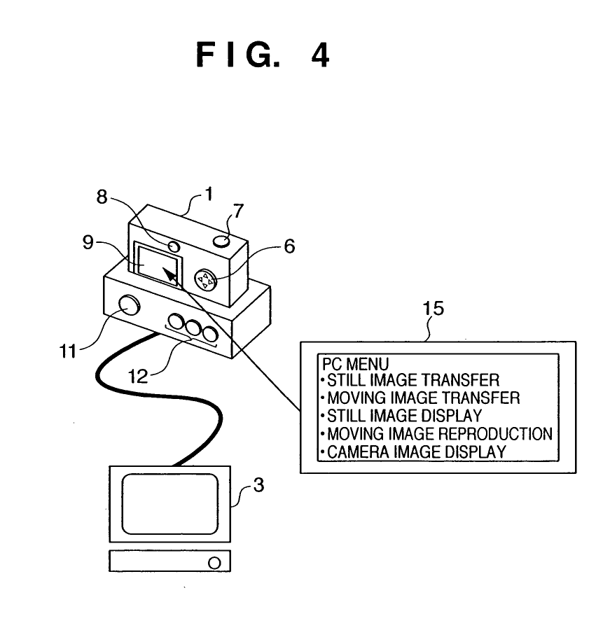

FIG. 4 shows an example of a menu for a PC to be displayed on the LCD 9 when the PC 3 is selected by the connection destination selection unit 12 of the cradle 2.

In FIG. 4, the “still image transfer” is an item for transferring a desired still image recorded on a detachable recording medium to the PC 3. The “moving image transfer” is an item for transferring desired moving image recorded on a detachable recording medium to the PC 3. The “still image display” is an item for displaying a desired still image recorded on a detachable recording medium on the display of the PC 3. The “moving image display” is an item for displaying desired moving image data recorded on a detachable recording medium on the display of the PC 3. The “camera image display” is an item for displaying moving image data being taken by the digital camera 1 on the display of the PC 3. The user can use the function set button 6 to select the “still image transfer”, “moving image transfer”, “still image display”, “moving image display” or “camera image display”.

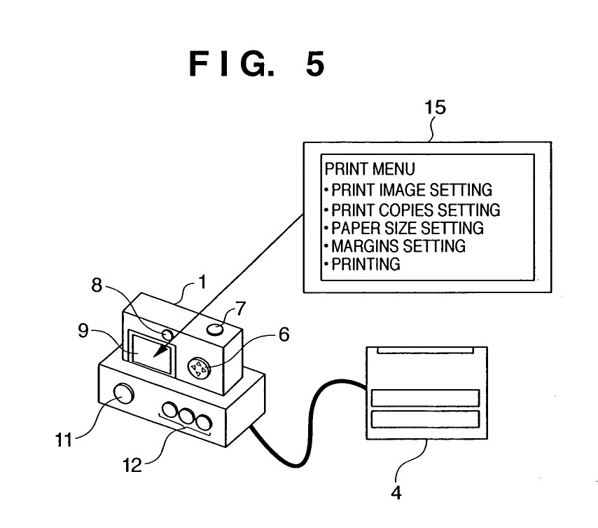

FIG. 5 shows an example of a menu for a printer to be displayed on the LCD 9 when the printer 4 is selected by the connection destination selection unit 12 of the cradle 2.

In FIG. 5, the “print image setting” is an item for making settings for a still image to be printed by the printer 4. The “print copies setting” is an item for making settings about the number of print copies. The “paper size setting” is an item for making settings about the paper size. The “margins setting” is an item for making settings about margins. The “printing” is an item for causing the printer 4 to print the still image data set at the “print image setting”. The user can use the function set button 6 to select the “print image setting”, “print copies setting”, “paper size setting”, “margins setting” or “printing”.

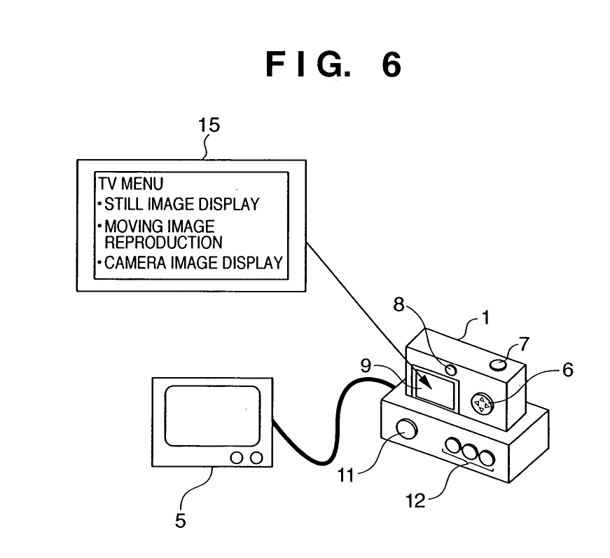

FIG. 6 shows an example of a menu for a TV to be displayed on the LCD 9 when the TV 5 is selected by the connection destination selection unit 12 of the cradle 2.

In FIG. 6, the “still image display” is an item for displaying a desired still image recorded on a detachable recording medium on the display of the TV 5. The “moving image display” is an item for displaying desired moving image data recorded on a detachable recording medium on the display of the TV 5. The “camera image display” is an item for displaying moving image data being taken by the digital camera 1 on the display of the TV 5. The user can use the function set button 6 to select the “still image display”, “moving image display” or “camera image display”.

FIG. 7 is a block diagram showing an example of configuration of the digital camera 1 and the cradle 2 according to this embodiment.

As shown in FIG. 7, the digital camera 1 is provided with an image capture unit 20, an captured image signal processing unit 30, a control unit 40, an operation unit 50 and a display unit 60.

The image capture unit 20 has an image capture lens 21, such as a focus lens and a zoom lens, and an image capture device (such as a CCD sensor) 22 for capturing an image of an object by means of photoelectric conversion. An image of an object passing through the image capture lens 21 is focused on the light-receiving surface of the image capture device 22, and electric charge according to the light quantity of the focused object is accumulated. Furthermore, the image capture unit 20 has a finder 8 and a flash device 23. The area to be taken can be checked with the use of the finder 8. The flash device 23 functions by emitting light when energy accumulated in a condenser is supplied to a discharge tube.

At the captured image signal processing unit 30, an analog signal outputted from the image capture device 22 is separated into R, G and B components, and white balance is adjusted. Furthermore, the captured image signal processing unit 30 performs gamma correction, sequentially A/D converts the R, G and B signals at necessary timings, and outputs obtained digital image data to the control unit 40.

The control unit 40 has a CPU 41 and a memory unit 42. The CPU 41 performs overall control of the units within the digital camera 1 based on an operation signal inputted from the operation unit 50. The memory unit 42 controls a non-volatile memory and a main memory. In the non-volatile memory, there is stored data to be held even when the power source of the digital camera 1 is off, such as information about settings by a user or values adjusted at shipment. Image data indicating a menu for a PC, image data indicating a menu for a printer and image data indicating a menu for a TV are also stored in the non-volatile memory. The main memory has a function as a frame memory for storing data outputted from the captured image signal processing unit 30, a function as a system memory f or loading various programs and a function as a work area.

The operation unit 50 detects a switch operation by the user and outputs a control signal to the control unit 40. The power switch 51 switches on/off of the power source of the digital camera 1. The release button 7 has a two-stage pressing structure with a half-pressing stage and a full-pressing stage. AF and AE are locked by half stroke, and a taken image is acquired by full stroke. A zooming button 52 sets the magnification of the zoom lens. In addition to these switches, a button using a rotary mode dial or a cross key may be set on the operation unit 50, and such button is generically referred to as a function set button 6. Operations to be set by the function set button 6 includes file formatting, special functions, decision/storage, switching of display and the like.

The display unit 60 is provided with the LCD 9 and an LCD driving circuit 61. The LCD 9 is controlled by the LCD driving circuit 61 to display image data, and it also displays a menu for communicating with an external device via the cradle 2. Furthermore, the digital camera 1 is provided with a connector 70 for connecting to the cradle 2, and by the connector 70 being connected with a connector 101 on the cradle 2, communication with the cradle 2 is enabled.

The cradle 2 has a communication unit 100, an operation unit 110 and a control unit 120. The communication unit 100 is provided with a cradle connector 101 for connecting to the digital camera 1, the USB connector 13A for connecting to the PC 3, the USB connector 13B for connecting to the printer 4, an A/V output connector 105 for connecting to the TV 5, a camera connection detector 102 provided for each connector, a USB connection detector 103, an A/V connection detector 104 and the like. Each of the connection detectors 102, 103 and 104 detects whether or not an external device is connected to each connector and outputs the detected condition to the control unit 120.

The operation unit 110 is provided with the power switch 11 for setting on/off of the power source of the cradle 2 and the connection destination selection unit 12 for selecting a connection destination of the digital camera 1. When a switch operation by the user is detected, an operation signal is outputted to the control unit 120.

The control unit 120 has a CPU 121 and a memory unit 122. The CPU 121 controls each unit of the cradle 2 in accordance with an interface control program stored in the memory unit 122 in advance. The memory unit 122 stores a connection destination selected by the user. The camera connection detector 102, the USB connection detector 103, the A/V connection detector 104 are connected to the control unit 120, and each of detection signals from the detectors is inputted into the control unit 120. When a detection signal is inputted into the control unit 120, and a communicable external device is detected, the communicable external device is displayed on the LCD 9 of the digital camera 1. Furthermore, based on an operation signal received from the operation unit 110, the control unit 120 controls a corresponding circuit. If an external device is selected by the connection destination selection unit 12, the control unit 120 switches the settings for an external device to communicate with and the operation mode of the digital camera 1 to those for communicating with the selected external device and then displays a menu for communicating with the selected external device on the LCD 9.

On the other hand, if a communicable external device is not detected even though the digital camera 1 is mounted on the cradle 2 and the power source of the digital camera 1 is on (that is, in the case where a cable is disconnected from the cradle 2 or the external device or in the case where the power source of the external device is off), then a warning to that effect is displayed on the LCD 9 of the digital camera 1 to warn the user. When a connection destination selected by the connection destination selection unit 12 is not in a communicable condition, a warning to that effect is also displayed on the LCD 9 of the digital camera 1 to warn the user.

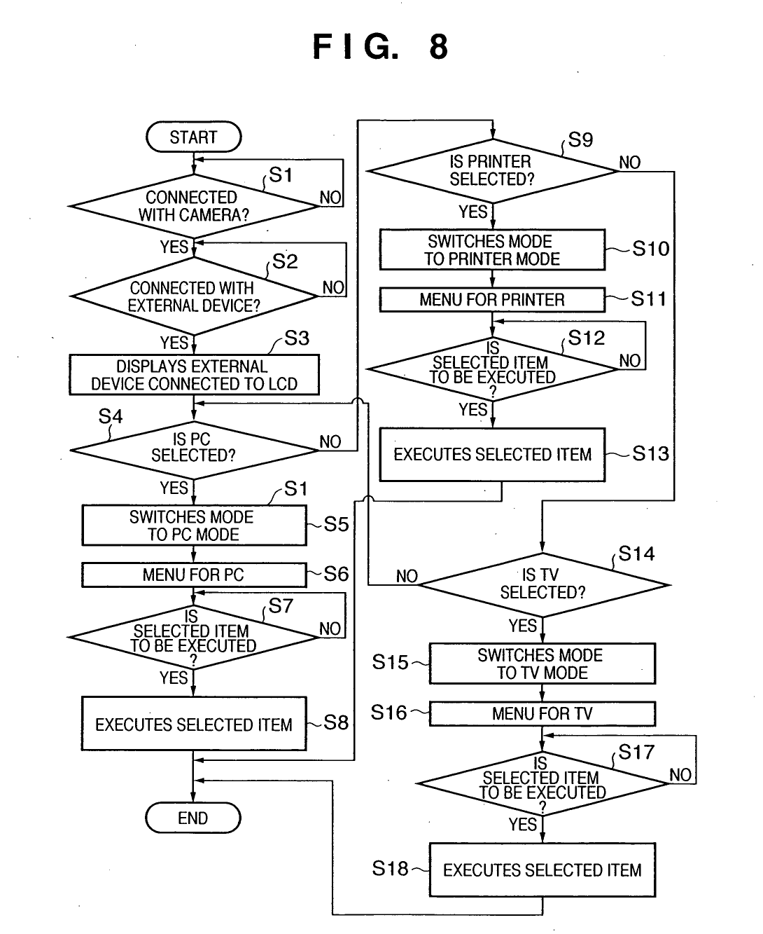

FIG. 8 is a flowchart showing the operation of the cradle 2.

In FIG. 8, at step S1, it is determined whether or not the digital camera 1 has been mounted in the reception portion 10 of the cradle 2. If connection of the digital camera 1 is confirmed at step S1, then the condition of connection to the cradle 2 is determined about external devices communicable with the digital camera 1 at step S2. If there exist external devices communicable with the digital camera 1, then the communicable external device is displayed on the LCD 9 of the digital camera 1 at step S3. In accordance with the display, the user can select a connection destination of the digital camera 1. At step S4, it is determined whether the connection destination of the digital camera 1 is the PC 3. If the PC 3 is selected as the connection destination, then the operation mode of the digital camera 1 is switched to the PC mode, an operation mode for communicating with the PC 3 at step S5. If the operation mode is switched to the PC mode at step S5, then the menu for a PC is displayed on the LCD 9 of the digital camera the digital camera 1 at step S6. At step S7, it is determined whether execution of a selected item has been instructed. If execution of a selected item has been instructed, then the selected item is executed at step S8.

If the selected connection destination is not the PC 3 at the above step S4, then it is determined whether the selected connection destination is the printer 4 at step S9. If the printer 4 is selected as the connection destination, then the operation mode of the digital camera 1 is switched to the printer mode, an operation mode for communicating with the printer 4 at step S10. If the operation mode is switched to the printer mode at step S10, then the menu for a printer is displayed on the LCD 9 of the digital camera the digital camera 1 at step S11. At step S12, it is determined whether execution of a selected item has been instructed. If execution of a selected item has been instructed, then the selected item is executed at step S13.

Furthermore, if the selected connection destination is not the printer 4 at the above step S9, then it is determined whether the selected connection destination is the TV 5 at step S14. If the TV 5 is selected as the connection destination, then the operation mode of the digital camera 1 is switched to the TV mode, an operation mode for communicating with the TV 5 at step S15. If the operation mode is switched to the TV mode at step S15, then the menu for a TV is displayed on the LCD 9 of the digital camera the digital camera 1 at step S16. At step S17, it is determined whether execution of a selected item has been instructed. If execution of a selected item has been instructed, then the selected item is executed at step S18.

### SECOND EMBODIMENT

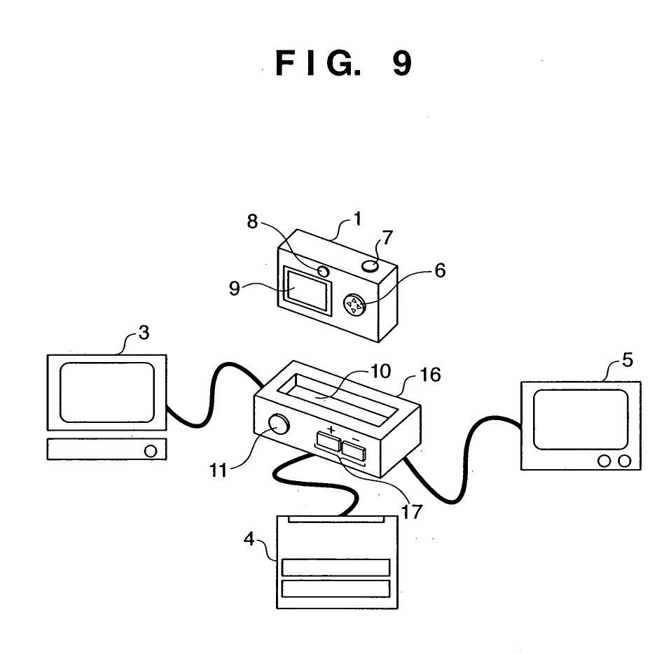

FIG. 9 is a schematic diagram of a camera system according to a second embodiment of the present invention.

The camera system according to the second embodiment is provided with a cradle 16 instead of the cradle 2 and a connection destination selection unit 17 instead of the connection destination selection unit 12. The connection destination selection unit 17 has a + button and a − button. If the + button or the − button is pressed, the cradle 16 sequentially switches external devices to be a connection destination of the digital camera 1. The connection destination selection unit 12 of the first embodiment has to be provided with the same number of the buttons as the number of external devices to be connected to the cradle 2, while the connection destination selection unit 17 of the second embodiment has to be provided with only two buttons even if the number of external devices to be connected to the cradle 2 is more than two.

As for the other units of the configuration, the same reference numerals are given to those having the same functions as in FIG. 1, and description thereof is omitted.

According to the connection device according to each of the above-described embodiments, it is possible to change the operation of an image capturing device such a digital camera, a digital video camera and a mobile telephone with a camera, according to the connection destination of the image capturing device. Thereby, it is possible to solve the inconvenience that a user has to check the connection destination of an image capturing device and manually select a menu appropriate for the connection destination.

Furthermore, when any of the external devices 3 to 5 is selected, a menu appropriate for the selected connection destination is displayed on the LCD 9 of the digital camera 1. Since items which cannot be used at the selected connection destination are not displayed, the operability is improved.

Furthermore, since a menu appropriate for the PC 3 is displayed on the LCD 9 of the digital camera 1 if the PC 3 is selected as the connection destination, the operability in communication with the PC 3 is improved.

Furthermore, if the printer 4 is selected as the connection destination, a menu appropriate for the printer 4 is displayed on the LCD 9 of the digital camera 1. Thereby the operability in communication with the printer 4 is improved.

Furthermore, if the TV 5 is selected as the connection destination, a menu appropriate for the TV 5 is displayed on the LCD 9 of the digital camera 1. Thereby the operability in communication with the TV 5 is improved.

The present invention is not limited to the above embodiments and various changes and modifications can be made within the spirit and scope of the present invention. Therefore, to apprise the public of the scope of the present invention the following claims are made.

What is claimed is:

1. A connection device which has a reception portion for an image capturing device to be mounted in and communicably connects the image capturing device to multiple external devices, comprising:
a selection unit adapted to select an external device to communicate with the image capturing device from among the multiple external devices; and
a setting unit adapted to set the operation mode of the image capturing device to a mode for communicating the selected external device.

2. The connection device according to claim 1, having a function of displaying a menu showing operation modes operable at the selected external device on the image capturing device.

3. The connection device according to claim 1, wherein
the multiple external devices include at least two of a personal computer, a printer and a television; and
the connection device further comprises:
a connection unit adapted to connect the external device; and
a detection unit adapted to detect whether or not the external device is connected.

4. The connection device according to claim 2, having a function of, if the selected external device is a personal computer, displaying on the image capturing device a menu for setting at least one operation mode among a mode for transferring image data held by the image capturing device to the personal computer, a mode for transferring moving image data held by the image capturing device to the personal computer, a mode for displaying the image data on the personal computer, a mode for reproducing the moving image data on the personal computer and a mode for displaying an image being displayed on the image capturing device on the personal computer.

5. The connection device according to claim 2, having a function of, if the selected external device is a printer, displaying on the image capturing device a menu for setting at least one operation mode among a mode for selecting an image to be printed from among image data held by the image capturing device, a mode for setting the number of print copies, a mode for setting the paper size and a mode for setting margins.

6. The connection device according to claim 2, having a function of, if the selected external device is a television, displaying on the image capturing device a menu for setting at least one operation mode among a mode for displaying image data held by the image capturing device on the television, a mode for reproducing moving image data held by the image capturing device on the television and a mode for displaying an image being displayed on the image capturing device on the television.

7. A control method for a connection device which has a reception portion for an image capturing device to be mounted in and communicably connects the image capturing device to multiple external devices, comprising:
a selection step of selecting an external device to communicate with the image capturing device from among the multiple external devices; and
a setting step of setting the operation mode of the image capturing device to a mode for communicating the selected external device.

8. The method according to claim 7, further comprising a step of displaying a menu showing operation modes operable at the selected external device on the image capturing device.

9. The method according to claim 7, wherein the multiple external devices include at least two of a personal computer, a printer and a television; and
the connection device further comprises:
a connection unit adapted to connect the external device; and
a detection unit adapted to detect whether or not the external device is connected.

10. The method according to claim 8, further comprising a step of, if the selected external device is a personal computer, displaying on the image capturing device a menu for setting at least one operation mode among a mode for transferring image data held by the image capturing device to the personal computer, a mode for transferring moving image data held by the image capturing device to the personal computer, a mode for displaying the image data on the personal computer, a mode for reproducing the moving image data on the personal computer and a mode for displaying an image being displayed on the image capturing device on the personal computer.

11. The method according to claim 8, further comprising a step of, if the selected external device is a printer, displaying on the image capturing device a menu for setting at least one operation mode among a mode for selecting an image to be printed from among image data held by the image capturing device, a mode for setting the number of print copies, a mode for setting the paper size and a mode for setting margins.

12. The method according to claim 8, further comprising a step of, if the selected external device is a television, displaying on the image capturing device a menu for setting at least one operation mode among a mode for displaying image data held by the image capturing device on the television, a mode for reproducing moving image data held by the image capturing device on the television and a mode for displaying an image being displayed on the image capturing device on the television receiver.
